(19) United States
(12) Patent Application Publication
(10) Pub. No.: US 2008/0093284 A1
(43) Pub. Date: Apr. 24, 2008

(54) UNITARY MOBILE POWER GENERATION AND WATER MANAGEMENT FACILITY

(75) Inventors: KEVIN SLOUGH, High River (CA); TROY LUPUL, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, US

(73) Assignee: COMBO ENERGY HOLDINGS LTD., Calgary (CA)

(21) Appl. No.: 11/551,549

(22) Filed: Oct. 20, 2006

(51) Int. Cl. C02F 9/02; C02F 9/08; C02F 9/14

(52) U.S. Cl. 210/205; 210/257.2; 210/299; 210/416.3

(57) ABSTRACT

A unitary mobile power generation and water management facility is presented. The unitary facility includes a multitude of basic service components mounted on a mobile platform. The unitary basic services facility may include interconnected units, such as: a water storage and distribution unit, a wastewater unit, and a power generation and distribution unit.

### FIELD OF THE INVENTION

The invention relates generally to the provision of basic services in remote geographical locations, and, in particular, to a unitary mobile power generation and water management facility.

### BACKGROUND OF THE INVENTION

Working in remote geographic locations or environmentally sensitive areas present challenges in providing basic services to work crews. For example, oil and gas drilling/exploration, forestry management, tree planting and logging are typical work environments with remote work sites where basic services need to be provided on a sustained, reliable basis to work crews. Similarly, basic services need to be provided at remote camp sites where workers may need to stay for long periods of time, often weeks or months.

Furthermore, in situations such as natural and man made disasters, access to basic services may be impossible because the existing service infrastructure is severely damaged or contraindicated, as the existing infrastructure is contaminated and unreliable.

Sustained access to basic services may also be required when an existing service infrastructure is being maintained, repaired, or expanded as the services infrastructure being worked on is shutdown.

Even if fresh water may be present near a work site or camp site, in an environmentally/ecologically sensitive area access to basic services may still be required to be provided separately so as not to disturb or contaminate the area.

Currently, individual suppliers are separately retained to provide water distribution, usually potable water, wastewater, e.g., sewage, treatment, and power generation and distribution. Problems may arise in connecting multi-supplier equipment to provide basic services in an integrated fashion, typically due to a lack of standardization and perhaps expertise across the multiple components required. Separate suppliers are chosen to provide a solution, for example, for each of a water storage and distribution component, water reclamation and treatment component, power generation and distribution component, etc. Each component may be delivered from a different originating geographical location to the work camp site, each component incurring a different transport time delay and transportation cost. Each component may be delivered with a different mode of transportation for example by all-terrain transport, air-lift, air-drop, boat, portage, etc.

Even with best intentions in mind, equipment mismatch is still possible; for example, the water reclamation and treatment component has a smaller throughput than that of the water storage and distribution component, which requires different sized piping and therefore requiring an unnecessarily large inventory of parts. Because different suppliers are retained for the water storage and distribution component, and the water reclamation and treatment component, repair crews are only able to respond to failures on different schedules while neither water component can be operated without the other.

Additional overhead is incurred in matching water services to the power generation component. Typical impediments include power rating mismatches, 2-phase/3-phase power input mismatches, connection fittings, etc. Power is not only required in the provisioning of water pumping for water services; electrical power may also be required for water reclamation and treatment. While is it important to provide power to the water side of the basic services solution, additional power is required to sustain the work camp.

There is a need to mitigate the above-mentioned problems in order to minimize transportation costs, camp set-up time and the effort spent in general on providing suitable water and power amenities to remote worksites.

### SUMMARY OF THE INVENTION

In accordance with an aspect of the invention, a transportable unitary facility is provided for providing power, potable water and waste water management to a site, the unitary facility having:
a mobile platform having mounted thereon:
a water storage tank for providing water to the site;
a wastewater facility for receiving wastewater from a wastewater source containing organic waste; and
at least one generator for providing power to the site.

In one embodiment, the wastewater facility comprises a wastewater holding tank, which tank can be picked up for disposal off site. In another embodiment, the wastewater facility further comprises a wastewater treatment system for producing a treated water effluent, which treated water effluent can then be discarded on site or stored in the wastewater holding tank for disposal off site. In one embodiment, the wastewater treatment system has a gravity settling tank, an aeration tank and a filtering tank with one or more membrane filters. In another embodiment, the wastewater treatment system has a gravity settling tank, an aeration tank and a secondary settling tank.

In one embodiment, the water storage tank is of a size to hold up to 5,000 gallons of water. In a further embodiment, the water storage tank is of a size to carry one legal axle load of water during transport, the facility being operational immediately upon delivery. In the alternative, the water storage tank of the facility can be delivered to the site empty and filled on site with a water truck. Preferably, the water storage tank is made of a lightweight material such as aluminum, stainless steel, plastic and the like. In yet another embodiment, the at least one generator outputs 105 kWatts of energy and comprises a diesel fuel tank.

In one embodiment, the unitary facility further comprises a distribution system operatively associated with the water storage tank for distributing the water to various components that may already be at site, for example, showers, toilets, washing machines, and the like. The distribution system may comprise a water pump. The at least one generator may be used to provide power for the distribution system and also power necessary to operate the wastewater

In accordance with a further aspect of the invention, a transportable unitary facility is provided for providing power, water and waste management to a site, the unitary facility having a plurality of separate interconnected units, comprising:
a water storage and distribution unit having a water storage tank for providing water to the site;
a wastewater unit for receiving wastewater from a wastewater source containing organic waste; and
a power generation and distribution unit having at least one generator for providing power to the site.

In one embodiment, the unitary facility further comprises a storage unit. In another embodiment, the water storage and distribution unit further comprises one or more of a washing machine, a shower, an eye wash station, a sink and a toilet, the water being dispensed and collected within the confines of the unitary facility. The water storage and distribution unit may comprise a water pump for supplying water to the washing machine, shower, eye wash station, sink and/or toilet.

In one embodiment, the wastewater unit comprises a wastewater holding tank. In another embodiment, the wastewater unit further comprises a wastewater treatment system for producing a treated water effluent. In one embodiment, the wastewater treatment system has a gravity settling unit, an aeration unit and a filtering unit with one or more membrane filters. In another embodiment, the wastewater treatment system has a gravity settling unit, an aeration unit and a secondary settling unit.

In accordance with a further aspect of the invention, a method for rendering a remote site self-contained is provided, comprising:
providing power to the remote site by means of at least one generator;
providing water to the remote site by means of a water tank; and
providing wastewater treatment capabilities to the remote site by means of a wastewater treatment facility for producing a treated water effluent;
whereby the at least one generator, the water tank and the waste water treatment facility are provided as a single, mobile unit.

Advantages in employing the unitary mobile power generation and water management facility are derived from a reduction in transport costs, a reduction in the number of transport trucks/air-lifts, and therefore from a time efficient unitary mobile basic services facility which is ready to operate on delivery.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic diagram showing, in accordance with one embodiment of the invention, a top plan view of a unitary mobile power generation and water management facility for use in providing basic services to a camp site;

FIG. 2 is a schematic diagram showing a side elevation view of the unitary mobile power generation and water management facility shown in FIG. 1;

FIG. 3 is a schematic diagram showing, in accordance with another embodiment of the invention, a top plan view of a compact unitary mobile power generation and water management facility for use in providing basic services to a work site;

FIG. 4 is a schematic diagram showing a side elevation view of the compact unitary mobile power generation and water management facility shown in FIG. 3; and

FIG. 5 is a schematic diagram showing a perspective view of the compact unitary mobile power generation and water management facility shown in FIG. 3.

### DETAILED DESCRIPTION OF THE EMBODIMENTS

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present invention may be practiced without these specific details.

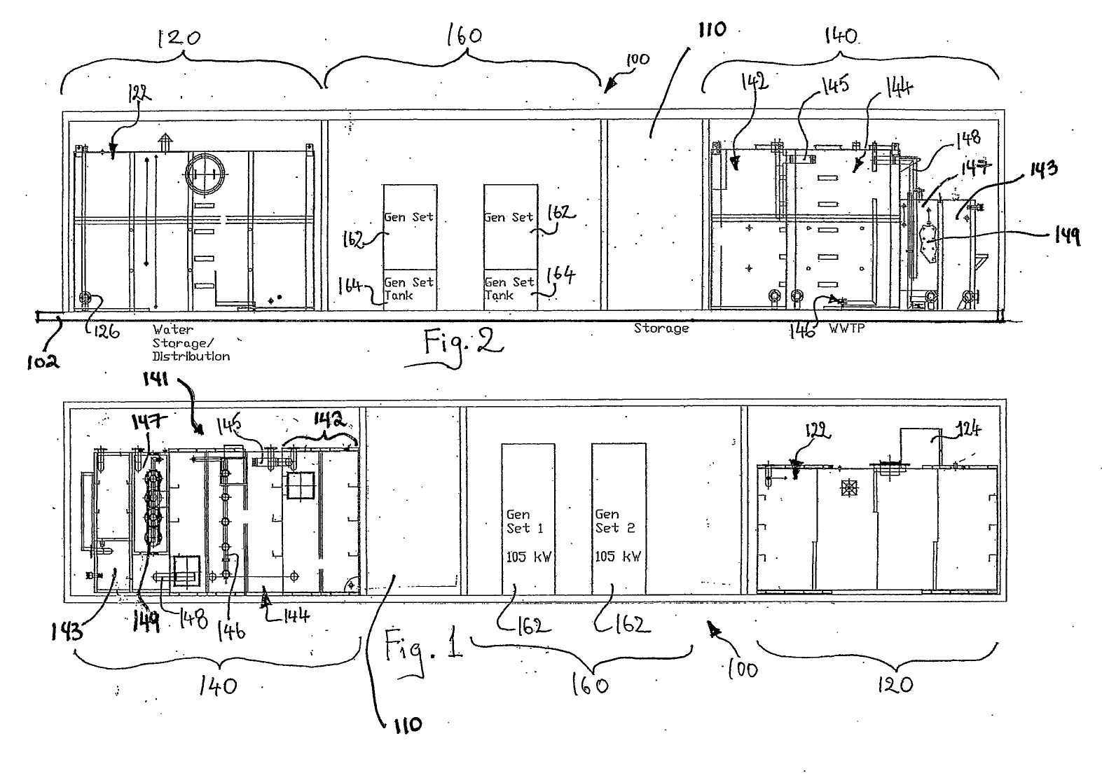

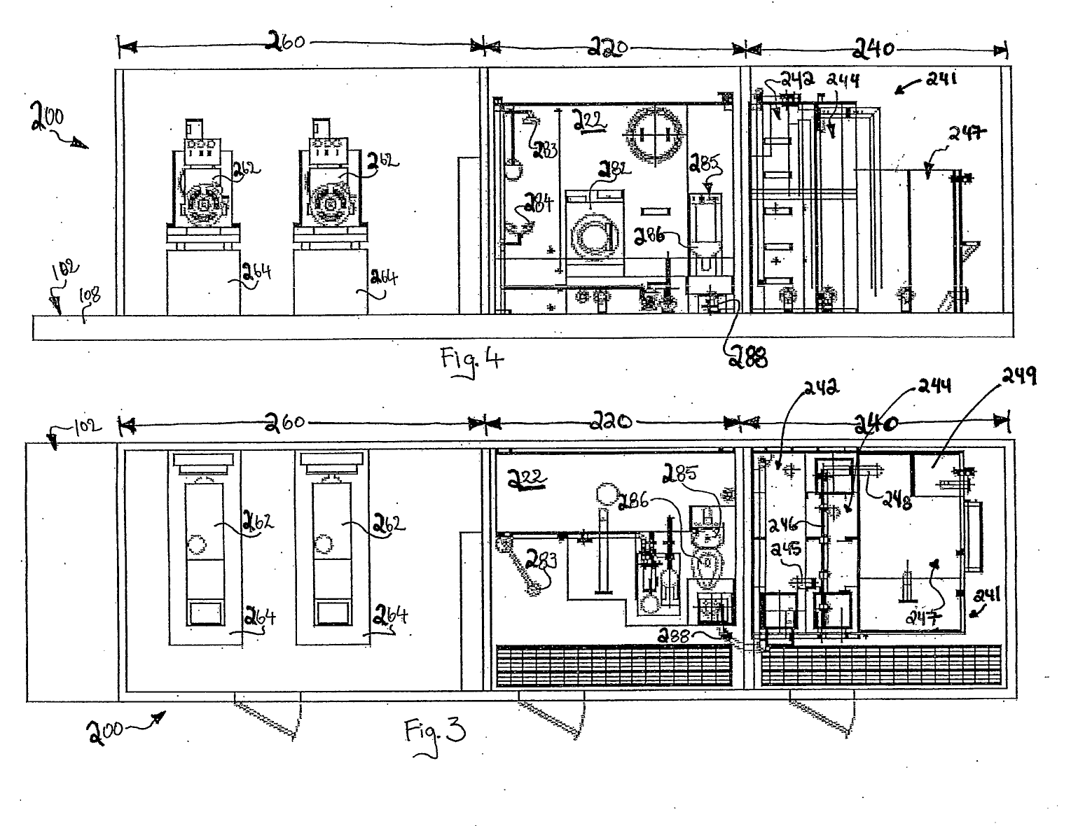

In accordance with an exemplary embodiment of the invention, a unitary mobile power generation and water management facility 100 is provided as shown in FIGS. 1 and 2. FIG. 1 shows a top plan view of the unitary mobile power generation and water management facility 100 and FIG. 2 shows a side elevation view.

This exemplary embodiment is most commonly used in camp sites where shower, sink and toilet facilities are already provided. For brevity, the unitary mobile power generation and water management facility will herein be referred to casually as the unitary mobile basic services facility, the unitary basic services facility, and the unitary facility.

With reference now to FIGS. 1-2, the unitary basic services facility 100 comprises a mobile platform shown here as a single unitary mobile skid 102, which can be, for example, a structural steel skid as known in the art. Without limiting the invention, unitary mobile skid 102 may be provided with attachment means configured to anchor the skid to a trailer, an attachment for air-lift, etc (not shown). In accordance with an exemplary implementation, the skid 102 may be 65 ft long by 10 ft wide, and generally comply with highway transport standards. The invention is not limited to highway transport standards compliance; the skid 102 may comply with railroad transport standards, or any other transport standard. The invention is not limited to a skid 102; the unitary basic services facility may also include a trailer, flatbed and the like.

The unitary mobile basic services facility 100 includes interconnected compartments or units, such as, but not limited to: a water storage and distribution unit 120, a wastewater unit 140, and a power generation and distribution unit 160.

The water storage and distribution unit 120 of unitary mobile facility 100, includes water storage tank 122. Without limiting the invention, the water storage tank 122 may be sized to hold 5,000 gallons of water. Preferably the water storage tank 122 is configured to accept one legal axle load of water in order to be operational immediately upon delivery, for example, to supply potable water and water for showers, toilets, sinks, and the like.

The water storage and distribution unit 120 of unitary mobile facility 100 also includes a water pump 124 for distributing the water. Without limiting the invention, the water pump 124 may be driven by an electric motor supplied with power from the power generation and distribution unit 160, or may be a fuel powered water pump. The use of redundant water pumps is also envisioned; redundant water pumps need not be limited to either electric motor driven or fuel powered.

A water distribution system such as water pump 124 may not be necessary if the unitary mobile facility 100 is installed at a higher elevation than that of the camp. Installation at a higher elevation may be desired to ensure water distribution that is not subject to water pump 124 operation or power availability. The installation of the unitary mobile facility 100 at a higher elevation so as not to pump water during distribution, may need to take into consideration water reclamation issues as will be described herein below. Water, which may be potable water, may be dispensed via water output port 126.

The wastewater unit 140 as shown in FIGS. 1 and 2 includes wastewater treatment system 141. In this embodiment, wastewater treatment system 141 comprises gravity settling or solids removal tank 142, aeration tank 144, and filtering tank 147. Solids removal tank 142 is configured to allow solids to settle to the bottom by gravity. The overflow from solids removal tank 142 is transferred to aerator tank 144, for example via an overflow spout 145.

In the aeration tank 144, air is injected via aerator 146 into the wastewater overflow from the solids removal tank 142. The aeration tank 144 may operate as a bioreactor, the aeration enhancing the biodegradation of the waste in the wastewater. In one embodiment the aeration tank 144 may be partially filled with biofilm carrier elements to promote growth of a biofilm to further enhance biodegradation. Any solids or precipitates still remaining after biodegradation remain in suspension in the water and the water overflows into filtering tank 147 via a pipe 148 for further wastewater treatment. In the filtering tank 148 one or more membrane filters 149 may be employed to filter out remaining solids which are pumped back to the solids removal tank 142. The filtered water is conveyed to a wastewater holding tank from which the treated water is either pumped for disposal or discharged on site.

The power generation unit 160 shown in FIGS. 1-2 includes redundant electrical power generators 162, each power generator being sized to provide power to the unitary basic services facility 100 and to the entire work camp being serviced. In accordance with an exemplary implementation 105 kW generators may be employed; one in service, the other on standby. The invention is not limited to using identical electrical power generators 162. It is contemplated that both generators may be used on a hot-standby basis, each generator 162 working substantially below respective maximum output.

At least one fuel tank 164 may also be collocated with the generators in the power generation unit 160. In accordance with an exemplary implementation the generators are run by diesel engines, the fuel tanks 164 storing diesel fuel. The power generation unit 160 may further include circuit breakers and power converters to respectively protect and provide various circuits.

A flex/storage compartment or unit 110 may be further provided in which a variety of equipment may be housed whether for storage or for protection against the elements while in operation. For example during transport water hoses, valves, hose junctions, electrical cables, distribution panels, fuel, and auxiliary equipment such as pumps may be stored in the storage space. During operation, the flex space 110 may house any combination of a wastewater disposal tank, at least one water lift station, and electrical outlets for plugging in vehicles and/or equipment.

Depending on the elevation at which the unitary mobile basic services facility 100 is installed compared to the work camp, a lift station may be necessary to return wastewater to the water treatment facility 140. Typically, the used water from showers and toilets flow by gravity and collects at the at least one lift station, which pumps the used water to the wastewater sewage treatment unit 140.

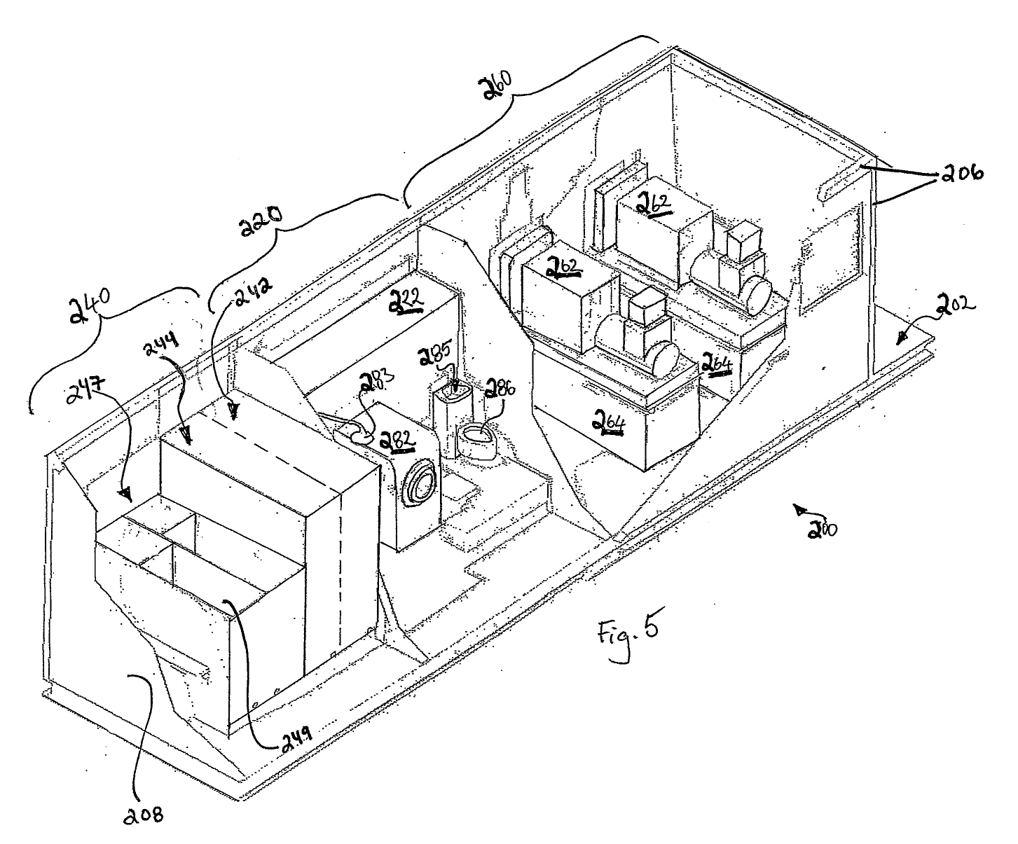

The exemplary embodiment of the invention shown in FIGS. 1 and 2 can be modified for use on a work site such as an oil rig site where amenities such as a shower, toilet, sink, washing machine and the like are not readily available. One such embodiment is shown in FIGS. 3 and 4. With reference now to FIGS. 4 and 5, the unitary mobile basic services facility 200 includes in series power generation and distribution unit 260, water storage and distribution unit 220, and wastewater unit 240. Power generation and distribution unit 260 includes two power generators 262 and two fuel tanks 264.

The wastewater unit 240 as shown in FIGS. 3 and 4 includes wastewater treatment system 241. In this embodiment, wastewater treatment system 241 comprises gravity settling or solids removal tank 242, aeration tank 244, and secondary setting tank 247. Solids removal tank 242 is configured to allow solids to settle to the bottom by gravity. The overflow from the solids removal tank 242 is transferred to aeration tank 244, for example by overflow spout 245.

In the aeration tank 244, air is injected via aerator 246 to provide oxygen to the wastewater. The aeration tank 244 may operate as a bioreactor, the aeration enhancing the biodegradation of the waste in the wastewater. In one embodiment the aeration tank 244 may be partially filled with biofilm carrier elements to promote growth of a biofilm to further enhance biodegradation. Any solids still remaining after biodegradation remain in suspension in the water and the water overflows into the secondary settling tank 247 via overflow pipe 248. In the secondary settling tank 247 a plurality of inclined plates (not shown) may be employed to enhance settling of remaining solids which are pumped back to the solids removal tank 242. The supernatant wastewater is conveyed to a wastewater holding tank 249 from which the treated water is either pumped for disposal or discharged on-site.

In a further embodiment (not shown), the wastewater unit may simple comprise a storage tank.

Water storage and distribution unit 220 includes water storage tank 222 for storing water and includes a variety of amenities, wherein fresh water is dispensed and collected within the confines of the unitary mobile basic services facility 100. Without limiting the invention, exemplary amenities include: a clothes washing machine 282, a shower 283, eye wash station 284, a sink 285 and a toilet 286. The water distribution cycle may be complex wherein fresh water is provided to the washing machine 182, the shower 183, the eye wash station 184, and sink 185. Wastewater is conveyed to the solids settling tank 242 by pump 288. Existing lift stations already on site may also be used.

FIG. 5 is a schematic diagram showing a perspective view of the mobile facility 200 in FIGS. 4 and 5. FIG. 5 shows the mobile platform, or skid 202. It is understood that skid 202 may be the platform of a flatbed trailer or truck. Skid 202 further includes external steel frame 206 extending therefrom, which frame 206 comprises two aluminum sheets 208 having insulation sandwiched therebetween. The insulation may be thermally bonded to one or both of the aluminum sheets. The exemplary construction is light and relatively strong given the size thereof, able to support a legal weight of 65,000 lbs.

Advantages in employing the unitary mobile power generation and water management facility 100 or 200 are derived from a reduction in transport costs, a reduction in the number of transport trucks/air-lifts, and therefore from a time efficient unitary mobile basic services facility 100 or 200 which is ready to operate on delivery.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

The embodiments presented herein are exemplary only, and persons skilled in the art would appreciate that variations to the embodiments may be made without departing from the spirit of the invention.

We claim:

1. A transportable unitary facility for providing power, water and waste water management to a site, comprising:
a mobile platform having mounted thereon:
a water storage tank for providing water to the site;
a wastewater facility for receiving waste water from a waste water source containing organic waste; and
at least one generator for providing power to the site.

2. The unitary facility according to claim 1, wherein the wastewater facility comprises a wastewater holding tank.

3. The unitary facility according to claim 1, wherein the wastewater facility comprises a wastewater treatment system.

4. The unitary facility according to claim 3, wherein the wastewater treatment system comprises a gravity settling unit, an aeration unit and a filtering unit having one or more membrane filters.

5. The unitary facility according to claim 3, wherein the wastewater treatment system comprises a gravity settling unit, an aeration unit and a secondary settling unit.

6. The unitary facility according to claim 1, wherein the water storage tank is sized to hold up to 5,000 gallons of water.

7. The unitary facility according to claim 1, wherein the water storage tank is sized to carry one legal axle load of water during transport, the unitary facility being operational immediately upon delivery.

8. The unitary facility according to claim 1, wherein the water storage tank is made of a lightweight material.

9. The unitary facility according to claim 8, wherein the lightweight material is selected from the group consisting of aluminum, stainless steel and plastic.

10. The unitary facility according to claim 1, wherein the at least one generator outputs 105 kWatts of energy and comprises a diesel fuel tank.

11. The unitary facility according to claim 1, further comprising a water distribution system mounted on the mobile platform.

12. The unitary facility according to claim 11, wherein the water distribution system comprises a water pump.

13. The unitary facility according to claim 1, further comprising a lift station configured to convey received wastewater to the wastewater treatment facility.

14. A transportable unitary facility for providing power, water and wastewater management to a site, the unitary facility having a plurality of separate units, comprising:
a water storage and distribution unit having a water storage for providing water to the site;
a wastewater unit for receiving wastewater from a wastewater source; and
a power generation and distribution unit having at least one generator for providing power to the site.

15. The unitary facility according to claim 14, further comprising a storage unit.

16. The unitary facility according to claim 15, wherein the water storage and distribution unit further comprises one or more of a washing machine, a shower, an eye wash station, a sink and a toilet.

17. The unitary facility according to claim 15, wherein the water storage tank is sized to carry one legal axle load of water during transport, the unitary facility being operational immediately upon delivery.

18. The unitary facility according to claim 15, further comprising a lift station configured to convey received wastewater from the wastewater source.

19. The unitary facility according to claim 15, wherein the wastewater unit comprises a wastewater holding tank.

20. The unitary facility according to claim 15, wherein the wastewater unit comprises a wastewater treatment system.

21. The unitary facility according to claim 20, wherein the wastewater treatment system comprises a gravity settling compartment, an aeration compartment and a filtering compartment having one or more membrane filters.

22. The unitary facility according to claim 20, wherein the wastewater treatment system comprises a gravity settling compartment, an aeration compartment and a secondary settling compartment.

23. A method for rendering a remote site self-contained, comprising:
providing power to the remote site by means of at least one generator;
providing water to the remote site by means of a water storage tank; and
providing wastewater treatment capabilities to the remote site by means of a wastewater facility for receiving wastewater from a wastewater source containing organic waste;
whereby the at least one generator, the water storage tank and the wastewater facility are provided as a single, mobile unit.

24. A method according to claim 23, further comprising installing the mobile unit at a higher elevation with respect to the site so that water can be distributed to the site by gravity.

25. A method according to claim 23, further comprising installing the mobile unit at a lower elevation with respect to the site, wastewater being collected from the site irrespective of power availability.
